(19) United States
(12) Patent Application Publication
(10) Pub. No.: US 2016/0140628 A1
(43) Pub. Date: May 19, 2016

(54) SYSTEM AND METHOD FOR DETERMINING A COST OF A CASTING PROCESS

(71) Applicant: Caterpillar Inc., Peoria, IL (US)

(72) Inventors: Srivenkatesh Somaskandan, Vellore (IN); Ajit Kumar Singh, Chennai (IN); Sivakumar Ramadoss, Chennai (IN); Sankarakrishnan Lakshminarasimhan, Chennai (IN); Ganesh L., Chennai (IN)

(73) Assignee: Caterpillar Inc., Peoria, IL (US)

(21) Appl. No.: 14/543,962

(22) Filed: Nov. 18, 2014

(51) Int. Cl. G06Q 30/02

(52) U.S. Cl. CPC G06Q 30/0283

(57) ABSTRACT

A computer implemented method for determining a cost of a casting process includes receiving a user input, via a Graphical User Interface (GUI), indicative of part information that is associated with a part manufactured by the casting process. The method includes receiving a user input, via the GUI, to select a casting parameter associated with the casting process. The casting parameter includes material and post-treatment parameter, mold and core parameter, foundry process parameter, and machining and setup parameter. The method includes receiving a user input, via the GUI, indicative of a variable associated with the casting parameter and retrieving a cost information associated with the casting parameter from a database. The method further includes determining a parameter cost based on the cost information and the variable and, generating an output, via the GUI, indicative of the cost of the casting process for the part.

### TECHNICAL FIELD

The present disclosure generally relates to a system and method for determining a cost. More particularly, the present disclosure relates to a system and a method of determining a cost of a casting process based on various casting parameters.

### BACKGROUND

Typically, manufacturing a part by a casting process entails a cost dependent on various parameters. Accurate determination of such cost may be important for optimizing the casting process. For example, a manufacturer or a customer may require details of such cost for selecting a manufacturing location, material, process details etc. Conventional methods for estimating casting cost may not consider multiple parameters associated with the casting process. As such, the casting cost calculated thereby may be inaccurate. Further, such methods may not provide a customized output.

For reference, U.S. Patent publication No. 2007/0203810 is related to a method for supply chain modeling by a supply chain entity within a supply chain. The supply chain may include a plurality of supply chain entities. The method may include establishing a first supply chain model representing interrelationships between an inventory cost of the supply chain entity and supply capacities of the supply chain entity and establishing a second supply chain model based on the first supply chain model. The method may also include providing a plurality of values of the inventory cost to the second supply chain model to generate corresponding plural sets of desired values of the supply capacities and selecting a set of desired values of the supply capacities from the plural sets of desired values.

### SUMMARY OF THE DISCLOSURE

One aspect of the present disclosure relates to a computer implemented method for determining a cost of a casting process. The method includes receiving a user input, via a Graphical User Interface (GUI), indicative of a part information. The part information is associated with a part manufactured by the casting process. The method includes receiving a user input, via the GUI, to select a casting parameter associated with the casting process. The casting parameter includes material and post-treatment parameter, mold and core parameter, foundry process parameter, and machining and setup parameter. The method includes receiving a user input, via the GUI, indicative of a variable associated with the casting parameter and retrieving cost information associated with the casting parameter from a database. The method further includes determining a parameter cost associated with the casting parameter based on the cost information and the variable associated with the casting parameter and generating an output, via the GUI, indicative of the cost of the casting process for the part based on the part information and the parameter cost.

Another aspect of the present disclosure relates to system for determining a cost of a casting process. The system includes a Graphical User Interface (GUI) configured to receive a user input, a database configured to store information associated with the casting process and a processing device in communication with the GUI and the database. The processing device is configured to receive part information associated with a part manufactured by the casting process mad select a casting parameter associated with the casting process based on a user input. The processing device is configured to receive a variable associated with the casting parameter The casting parameter includes a material and a post-treatment parameter, a mold and core parameter, a foundry process parameter, and machining and setup parameter. The processing device is configured to retrieve a cost information associated with the casting parameter from a database. The processing device is configured to determine a parameter cost associated with the casting parameter based on the cost information and the variable associated with the casting parameter and generate an output indicative of the cost of the casting process for the part based on the part information and the parameter cost.

Another aspect of the present disclosure relates to a computer program product embodied on a non-transitory computer readable medium for determining a cost of a casting process. The computer program product causing a computer to perform operations includes receiving a user input, via a Graphical User Interface (GUI), indicative of a part information. The part information is associated with a part manufactured by the casting process. The operations includes receiving a user input, via the GUI, to select a casting parameter associated with the casting process The casting parameter includes at least one of material and post-treatment parameter, mold and core parameter, foundry process parameter, and machining and setup parameter. The operations also include receiving a user input, via the GUI, indicative of a variable associated with the casting parameter. The operations further include retrieving cost information associated with the casting parameter from a database and determining a parameter cost associated with the casting parameter based on the cost information and the variable associated with the casting parameter. The operations also include generating an output, via the GUI, indicative of the cost of the casting process for the part based on the part information and the parameter cost.

Other features and aspects of this disclosure will be apparent from the following description and the accompanying drawings.

### BRIEF DESCRIPTION OF THE DRAWINGS

FIG. 1 is a system for determining a cost of a casting process, according to an embodiment of the present disclosure;

FIG. 2 is a Graphical User Interface (GUI) of the system displaying a process tab for part information, according to an embodiment of the present disclosure;

FIG. 3 is a GUI of the system displaying a process tab for casting detail parameter, according to an embodiment of the present disclosure;

FIG. 4 is a GUI of the system displaying a process tab for material data parameter, according to an embodiment of the present disclosure;

FIG. 5 is a GUI of the system displaying a process tab for heat treatment parameter, according to an embodiment of the present disclosure;

FIG. 6 is a GUI of the system displaying a process tab for core making parameter, according to an embodiment of the present disclosure;

FIG. 7 is a GUI of the system displaying a process tab for core assembly parameter, according to an embodiment of the present disclosure;

FIG. 8 is a GUI of the system displaying a process tab for mold making parameter, according to an embodiment of the present disclosure;

FIG. 9 is a GUI of the system displaying a process tab for sand processing parameter, according to an embodiment of the present disclosure;

FIG. 10 is a GUI of the system displaying a process tab for melting parameter, according to an embodiment of the present disclosure;

FIG. 11 is a GUI of the system displaying a process tab for shake-out parameter, according to an embodiment of the present disclosure;

FIG. 12 is a GUI of the system displaying a process tab for consumables parameter, according to an embodiment of the present disclosure;

FIG. 13 is a GUI of the system displaying a process tab for finishing parameter, according to an embodiment of the present disclosure;

FIG. 14 is a GUI of the system displaying a process tab for inspection parameter, according to an embodiment of the present disclosure;

FIG. 15 is a GUI of the system displaying a process tab for pre-machining parameter, according to an embodiment of the present disclosure;

FIG. 16 is a GUI of the system displaying a process tab for setup parameter, according to an embodiment of the present disclosure;

FIG. 17 is a GUI of the system displaying a process tab for selecting scenario, according to an embodiment of the present disclosure;

FIG. 18 is a GUI of the system displaying a process tab for selecting report format, according to an embodiment of the present disclosure;

FIG. 19 is a GUI of the system displaying an exemplary output, according to an embodiment of the present disclosure;

FIG. 20 is a block diagram of an exemplary computer based system, according to an embodiment of the present disclosure; and

FIG. 21 is a flowchart of a method for determining a cost of a casting process, according to an embodiment of the present disclosure.

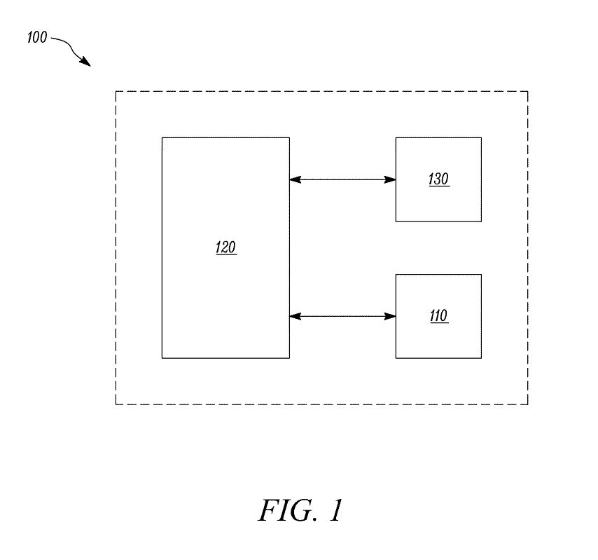

### DETAILED DESCRIPTION

Wherever possible, the same reference numbers will be used throughout the drawings to refer to same or like parts. FIG. 1 illustrates a block diagram of a system 100, according to an embodiment of the present disclosure. The system 100 may be employed to determine a cost of a casting process. In an example, the casting process may be a sand casting process. Such a casting process may be used to manufacture parts such as, an engine block. Such a casting process may be associated with various steps such as, post processing, inspection, mold making, core assembly, pre-machining, machine setup and the like. Each of the steps may be associated with a cost thereby adding to a total cost of the casting process.

The system 100 includes a Graphical User Interface (GUI) 110, a processing device 120 and a database 130. The GUI 110 may be at least one of a touch based interface, a keyboard based interface, a pointing device (e.g., a mouse) based interface, or a combination thereof

The processing device 120 may be in communication with the GUI 110 and the database 130. The processing device 120 may receive one or more user inputs via the GUI 110. The processing device 120 may be any microprocessor based system, for example, a computer. The processing device 120 may be configured to execute instructions and provide one or more outputs based on the user inputs.

The database 130 may be configured to store information associated with the casting process. For example, the database 130 may store cost information associated with various parameters of a casting process. The cost information may include a material cost, a machine cost, and a regional cost. For example, the machine cost may include a machine hour rate for various regions. Moreover, a labor cost, an energy cost for a particular region may also be stored in the database 130. The database 130 may also store information related to one or more parts manufactured by the casting process. The processing device 120 may be configured to lookup in the database 130 and retrieve data from the database 130. The database 130 may also be configured to receive output files from the processing device 120 and store the received files. In one embodiment, the database 130 may be an in-built memory that is integral with the processing device 120. In another embodiment, the database 130 may be external to the processing device 120.

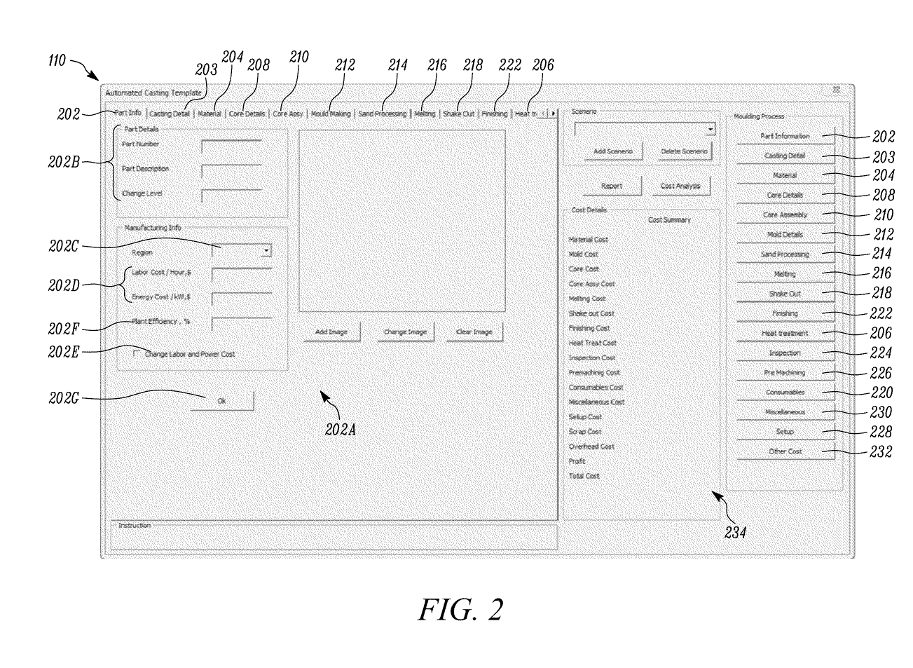

Referring to FIG. 2, the GUI 110 may include multiple graphical control elements. Each of the graphical control elements may allow a user to provide inputs related to various functions such as, but not limited to, selection of one or more features, creation of one or more files, and the like. The processing device 120 may be configured to receive the user inputs via one or more of these graphical control elements and accordingly perform tasks. More specifically, the system 100 may be configured to determine a cost of a casting process based on user inputs received via the GUI 110.

The GUI 110 may include a control element 202 that may allow the user to provide input corresponding to selection of part information parameter. The control element 202 may be a navigation button. The processing device 120 may receive the input via the control element 202 and may subsequently display or navigate to a process tab 202A of the GUI 110. The process tab 202A may be, for example, a window, a dialogue box, a page, etc. The process tab 202A may allow the user to provide an input that is indicative of the part information. The part information may include a part file and an associated part number.

In the illustrated embodiment, the process tab 202A may include control elements 202B, 202C and 202D. The control elements 202B may allow the user to input part details such as, part number, a part description (for e.g., housing) and a change level. The control elements 202B may be input boxes, drop-down menus, list boxes and the like. The control element 202C may allow the user to provide an input corresponding to a selection of a region. The control element 202C may be a drop-down menu or a list box that includes list of regions. The processing device 120 may be configured to receive the selection of a region via the control element 202. The processing device 120 may also be configured to lookup the database 130 and retrieve regional cost information such as, a labor cost, energy cost for the selected region from the database 130. Subsequently, the processing device 120 may auto-fill the retrieved information via the control elements 202D for display to the user on the GUI 110. Alternatively, the control elements 202D may also allow the user to input the cost information corresponding to the selected region.

The process tab 202A may also include a control element 202E that allows the user to give an instruction to change one or more inputs provided via the control elements 202D. The control element 202E may be a radio button or a check box. Moreover, upon selecting the control element 202E, the processing device 120 may receive the instruction via the control element 202E and allow the user to change the regional cost information via the control elements 202D.

The process tab 202A may also include a control element 202F that allows the user to provide input indicative of a plant efficiency. The process tab 202A may further include a control element 202G. The control element 202G may be a confirmation button. Upon clicking on the confirmation button 202G, the processing device 120 may receive and store the part information via the GUI 110 for further processing.

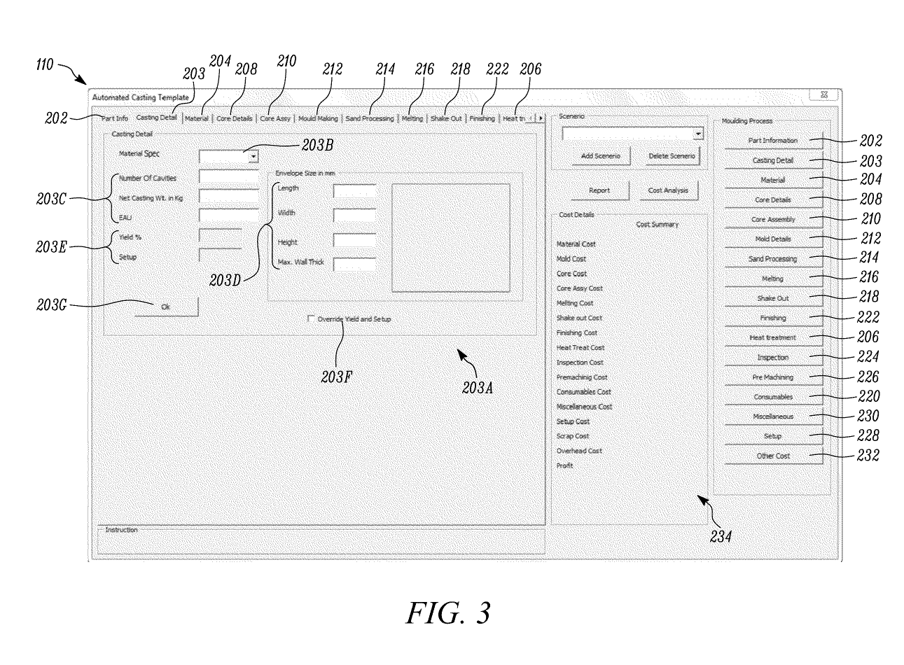

The GUI 110 may also include a control element 203 that may allow the user to provide input corresponding to selection of a casting detail parameter. The control element 203 may be a navigation button. Referring to FIG. 3, the processing device 120 may display or navigate to a process tab 203A on the GUI 110 as the user clicks on the navigation button 203. The process tab 203A may allow the user to provide input indicative of casting details associated with the casting detail parameter. The casting details may be, for example, material specification, number of cavities, net casting weight, Estimated Annual Usage (EAU), Yield percentage, setup, envelope size etc.

The process tab 203A may include a control element 203B that allows the user to provide input corresponding to selection of the material specification. The process tab 203A may also include control elements 202C that allows the user to provide input that is indicative of the casting details such as, number of cavities, net casting weight, EAU. The process tab 203A may also include control elements 202D that allows the user to provide input that is indicative of the casting details such as, length, width, height and maximum wall thickness of the envelope. Moreover, the processing device 120 may be configured to lookup the database 130 and retrieve information such as, the percentage of yield, the setup and the like from the database 130. Subsequently, the processing device 120 may auto-fill the retrieved information via control elements 203E for display to the user on the GUI 110. Alternatively, the control elements 203E may allow the user to input the setup and yield percentage information.

A control element 203F of the GUI 110 may allow the user to give an instruction to allow changing of one or more inputs provided via the control elements 203E. The control element 203F may be a radio button or a check box. Moreover, upon selecting the control element 202E, the processing device 120 may receive the instruction via the control element 202E and allow the user to change the inputs via the control elements 203E. The process tab 203A may further include a confirmation button 203G. Upon clicking on the confirmation button 203G, the processing device 120 may store the casting details associated with the casting detail parameter that are received via the GUI 110. Moreover, the processing device 120 may be configured to utilize the received part information and the casting details for further processing.

The processing device may also be configured to select a casting parameter associated with the casting process based on a user input. The casting process may be associated with multiple casting parameters that may contribute to a cost of the casting process. Accordingly, the GUI 110 may also include multiple navigation buttons associated with each casting parameter. The navigation buttons may allow the user to provide an input corresponding to selection of the casting parameter. The casting parameter may include a material and post-treatment parameter, a mold and core parameter, a foundry process parameter, and a machining and setup parameter. The processing device 120 may be configured to select the casting parameter upon receiving the input via the navigation buttons. Further, upon clicking on the navigation buttons, the processing device 120 may display or navigate to a process tab associated with the selected casting parameter. The process tab may include one or more control elements that allow the user to provide input that is indicative of a variable associated with the selected casting parameter.

In the illustrated embodiment, the GUI 110 may include navigation buttons 203, 204, 206 that may allow the user to provide input corresponding to selection of material and post-treatment parameters. The material and post-treatment parameters may include parameters such as, a material data, a scrap type and a heat treatment parameter. Specifically, the navigation buttons 204 and 206 may allow the user to provide input corresponding to selection of a material data parameter and a heat treatment parameter respectively.

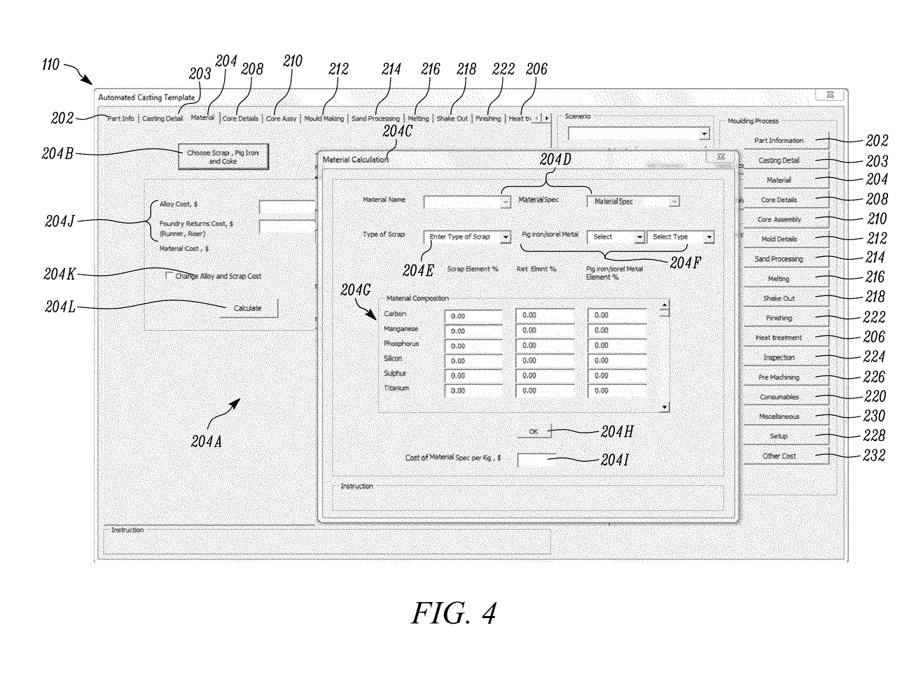

The material data parameter may be selected via the navigation button 204. Referring to FIG. 4, the processing device 120 may display a process tab 204A as the user clicks on the navigation button 204. The process tab 204A may allow the user to provide input that is indicative of variables associated with the material data parameter. The variables may be for example, type of scrap, pig iron or a sorel metal, details of material composition, type of coke etc. The process tab 204A may include a control element 204B that allows the user to provide an input corresponding to selection of scrap, pig iron type and coke type. The control element 204B may be a button. The processing device 120 may receive input via the control element 204B and display a dialogue box 204C on the GUI 110. Further, the dialogue box 204C may include multiple control elements that may allow the user to provide input the variables such as, type of scrap, pig iron or a sorel metal and details of material composition.

Accordingly, the dialogue box 204C may include control elements 204D, 204E, 204F, 204G, 204H and 204I. The processing device 120 may be configured to lookup the database and retrieve the material name and the material specification from the database. The processing device 120 may also be configured to auto-fill the material name and the material specification via the control elements 204D for display to the user on the GUI 110. Alternatively, the control elements 204D may also allow the user to input the material name and material specification.

The processing device 120 may be configured to receive inputs via the control elements 204D, 204E and 204F and lookup the database 130 to retrieve the details of material composition based on the received inputs. The details of material composition may be a percentage of scrap element, a percentage of foundry return and a percentage of pig iron, coke. The processing device 120 may also be configured to auto-fill the retrieved material composition details via the control element 204G for display to the user on the GUI 110. Additionally or optionally, the material composition details may also be input and/or modified by the user via the control element 204G.

The dialogue box 204C may further include a confirmation button 204H. Upon clicking on the confirmation button 204H, the processing device 120 may accept the data input via control elements 204D to 204G and calculate a cost associated with the material specification. Moreover, the processing device 120 may also auto-fill the cost via a control element 204I for display to the user on the GUI 110.

The processing device 120 may be configured to lookup the database 130 and retrieve cost information associated with the material data parameter such as, an alloy cost, a foundry returns cost etc. from the database 130. The processing device 120 may also be configured to auto-fill the retrieved cost information via control elements 204J of the process tab 204A for display to the user on the GUI 110. The process tab 204A may also include a a control element 204K that allows the user to give instruction to enable changing the cost information. The control element 204K may be a radio button or a check box. The processing device 120 may receive the instruction via the control element 204K and allows the user to change the cost information via the control elements 204J.

Further, the process tab 204A may also include a control element 204L that may allow the user to give an instruction to calculate a material cost. The processing device 120 may receive the instruction via the control element 204L and determines the material cost associated with the material data parameter. The processing device 120 may determine the cost based on the cost information and the variables associated with the material data parameter received via the control elements 204B to 204K.

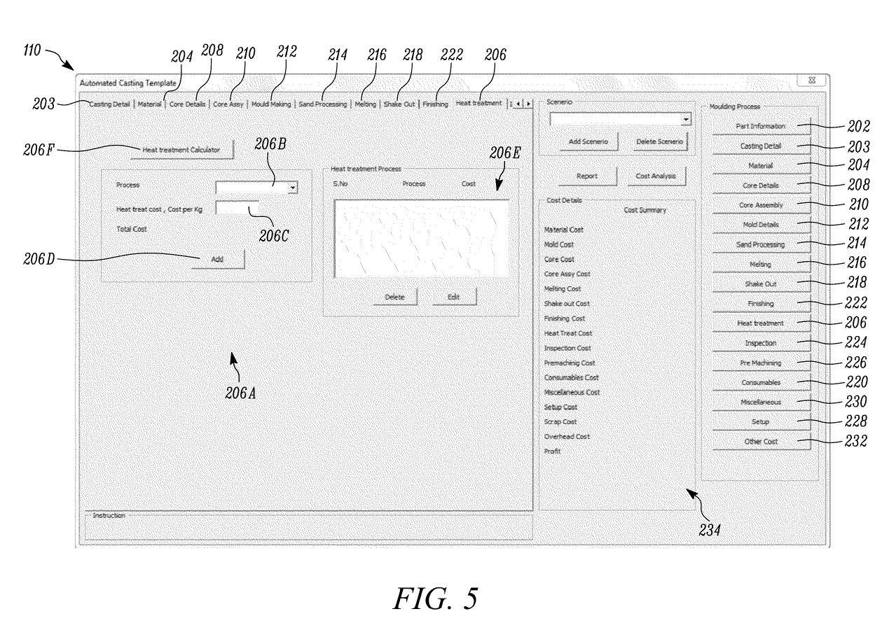

The heat treatment parameter may be selected via the navigation button 206. Referring to FIG. 5, the processing device 120 may display a process tab 206A as the user clicks on the navigation button 206. The process tab 206A may allow the user to provide input that is indicative of variables associated with the heat treatment parameter. The variables may be for example, a heat treatment process. The process tab 206A may include control elements, 206B, 206C, 206D, 206E, 206F that may allow the user to provide input indicative of the variables associated with the heat treatment parameter.

The control element 206B may allow the user to provide input corresponding to a selection of the process of heat treatment. The heat treatment processes may be for example, annealing, quenching etc. The control element 206B may be a drop-down menu. The processing device 120 may be configured to receive the user input to select the heat treatment process via the control element 206B. The processing device 120 may also be configured to lookup the database 130 and retrieve a cost information associated with the heat treatment parameter from the database 130. Subsequently, the processing device 120 may auto-fill the retrieved information via the control element 206C for display to the user on the GUI 110.

The process tab 206A may allow the user to add one or more heat treatment process contributing to a cost of casting process via a control element 206D for subsequent cost calculation. Moreover, upon clicking on the control element 206D, a summary of selected heat treatment process and associated cost may be displayed in a display box associated with the control element 206E. Moreover, the control element 206E may also allow editing and/or deleting of one or more process from a list of processes that are added for subsequent cost calculation.

Further, the process tab 206A may also include a control element 206F that may allow the user to give an instruction to calculate a heat treatment cost. The processing device 120 may receive the instruction via the control element 206F and determines the heat treatment cost associated with the heat treatment parameter. The processing device 120 may determine the cost based on the cost information and the variables associated with the heat treatment parameter received via the control elements 206B to 206E.

In the illustrated embodiment, the GUI 110 may include navigation buttons 208, 210, 212 that may allow the user to provide input corresponding to selection of mold and core parameters. The mold and core parameters may include parameters such as, core making, core assembly and mold making parameter. Specifically, the navigation buttons 208, 210, 212 may allow the user to provide input corresponding to selection of a core making parameter, a core assembly parameter and a mold making parameter respectively.

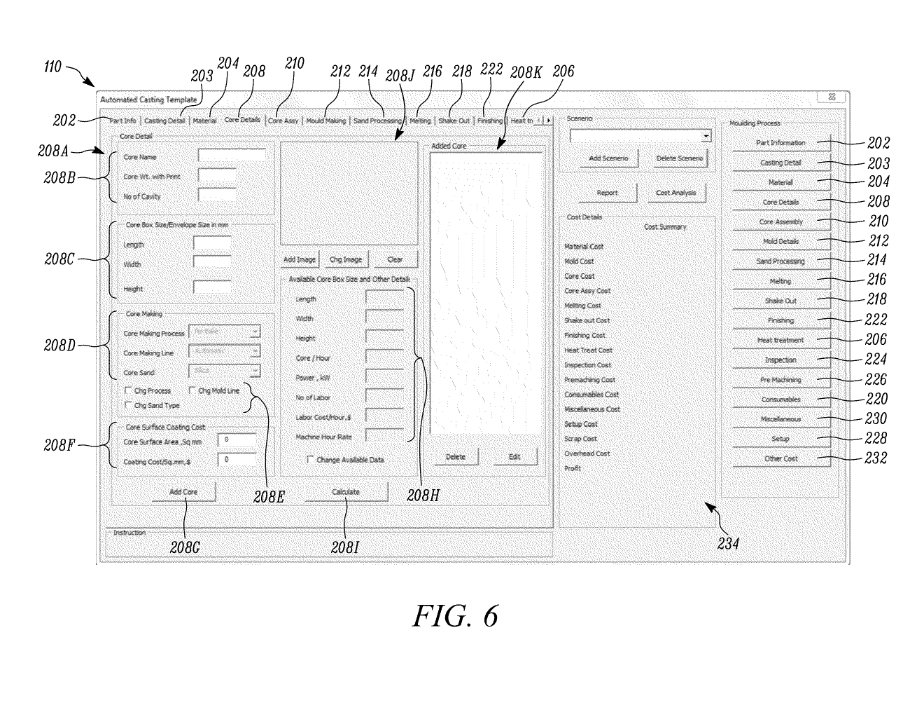

The core making parameter may be selected via the navigation button 208. Referring to FIG. 6, the processing device 120 may display a process tab 208A on the GUI 110 as the user clicks on the navigation button 208. The process tab 208A may allow the user to provide input that is indicative of variables associated with the core making parameter. The variables may be for example, core name, core weight, number of cavity, core box size, core making process, core making line, core sand, etc. The process tab 208A may include one or more control elements that may allow the user to provide input indicative of the variables associated with the core making parameter.

The process tab 208A may include control elements 208B that allow the user to provide input indicative of the variables such as, core name, core weight with print and number of cavities. The process tab 208A may further include control elements 208C that allow the user to provide input indicative of the variables such as, a length, a width and a height of the core box or an envelope. As shown, each of the control elements 208B to 208C may be input boxes.

The processing device 120 may be configured to lookup the database 130 and retrieve information associated with the core making parameter such as, a core making process, a core making line and a core sand etc. from the database 130. The processing device 120 may also be configured to auto-fill the retrieved information via control elements 208D of the process tab 208A for display to the user on the GUI 110. Alternatively, the control elements 208D may also allow the user to provide input corresponding to selection of the core making process, the core making line and the core sand. Further, the processing device 120 may be configured to allow the user to change a selection of the core making process, the core making line and the core sand via the control elements 208E. Each of the control elements 208E correspond to one of the core making process, core making line and the core sand that may be input via the control elements 208D. The control elements 208E may be radio buttons or check boxes.

The processing device 120 may be configured to lookup the database 130 and retrieve cost information associated with the material core making parameter such as, a core surface area, a coating cost etc. from the database 130. The processing device 120 may also be configured to auto-fill the control elements 208F with the retrieved cost information for display to the user on the GUI 110. Alternatively, the control elements 208F may allow the user to input the cost information. The processing device 120 may be configured to lookup the database 130 and retrieve variables associated with the core making parameter such as, a length, width, a height of the core box and other details such as, core/hour, power, number of labor, labor cost per hour, machine hour rate and the like from the database 130.

The processing device 120 may also be configured to auto-fill the retrieved variables via the control elements 208H of the process tab 208A for display to the user on the GUI 110. Additionally or optionally, the control elements 208H may also allow the user to provide input that is indicative of at least one of the variables. Moreover, upon clicking on a control element 208I, the processing device 120 may allow the user to modify the input provided via the control elements 208H.

The process tab 208A may include control elements 208J that allow the user to add an image and, modify or delete the added image from a display box associated with the control elements 208J.

The process tab 208A may allow the user to add one or more cores contributing to a cost of casting process via a control element 208G for subsequent cost calculation. Moreover, upon clicking on the control element 208G, a summary of selected core may be displayed in a display box associated with a control element 208K of the process tab 208A. The control element 208K may also allow editing and/or deleting of one or more cores from a list of cores that are added for subsequent cost calculation.

Further, the process tab 208A may also include a control element 208I that may allow the user to give an instruction to calculate a core cost. The processing device 120 may receive the instruction via the control element 208I and determines the core cost associated with the core making parameter. The processing device 120 may determine the cost based on the cost information and the variables associated with the core making parameter received via the control elements 208B to 208K and other relevant data retrieved from the database 130.

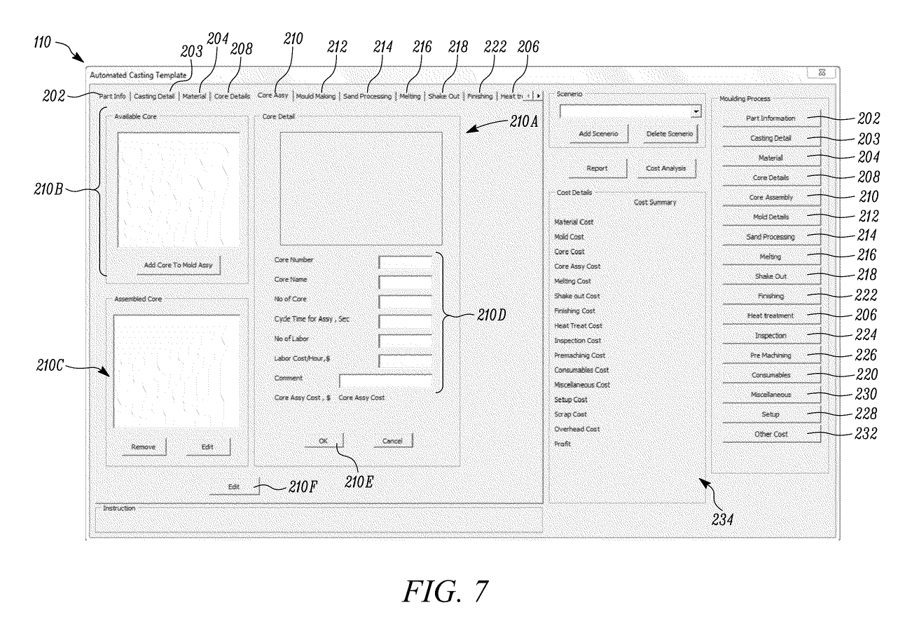

The core assembly parameter may be selected via the navigation button 210. Referring to FIG. 7, the processing device 120 may display a process tab 210A on the GUI 110 as the user clicks on the navigation button 210. The process tab 210A may allow the user to provide input that is indicative of variables associated with the core assembly parameter. The variables may be for example, cores that may be added to core assembly, a core number, a core name, number of cores, cycle time for assembly, number of labor, labor cost per time etc. The process tab 210A may include one or more control elements that may allow the user to provide input indicative of the variables associated with the core assembly parameter.

The processing device 120 may be configured to lookup the database 130 and retrieve details related to the cores that are added via the control elements 208B to 208K (See FIG. 6) of the process tab 208A. The processing device 120 may also be configured to auto-fill the retrieved cores via control elements 210B, 210D of the process tab 210A for display to the user on the GUI 110. Alternatively, the control element 210B may allow the user to provide input corresponding to selection of core to add to a core assembly. Moreover, the user may be allowed to select a core from the database 130. The control element 210D may include multiple input boxes that may allow the user to input details such as, a core number, a core name, number of cores, cycle time for assembly, number of labor, labor cost per time, comments etc. The control element 210B may allow inputs corresponding to selection of multiple cores. The processing device 120 may be configured to receive selection of the core and display the selected core summary in a display box associated with a control element 210C.

The control element 210C may also allow the user to provide input corresponding to deleting or editing of one or more of the cores displayed in the display box associated with a control element 210C. The process tab 210A may also include a button 210F that may allow the user to edit one or more inputs provided via the control elements of the process tab 210A.

Further, the process tab 210A may also include a control element 210E that may allow the user to give an instruction to calculate a core assembly cost. The processing device 120 may receive the instruction via the control element 210E and determines the core assembly cost associated with the core assembly parameter. The processing device 120 may determine the cost based on the cost information and the variables associated with the core assembly parameter received via the control elements 210B to 210E and other relevant data retrieved from the database 130.

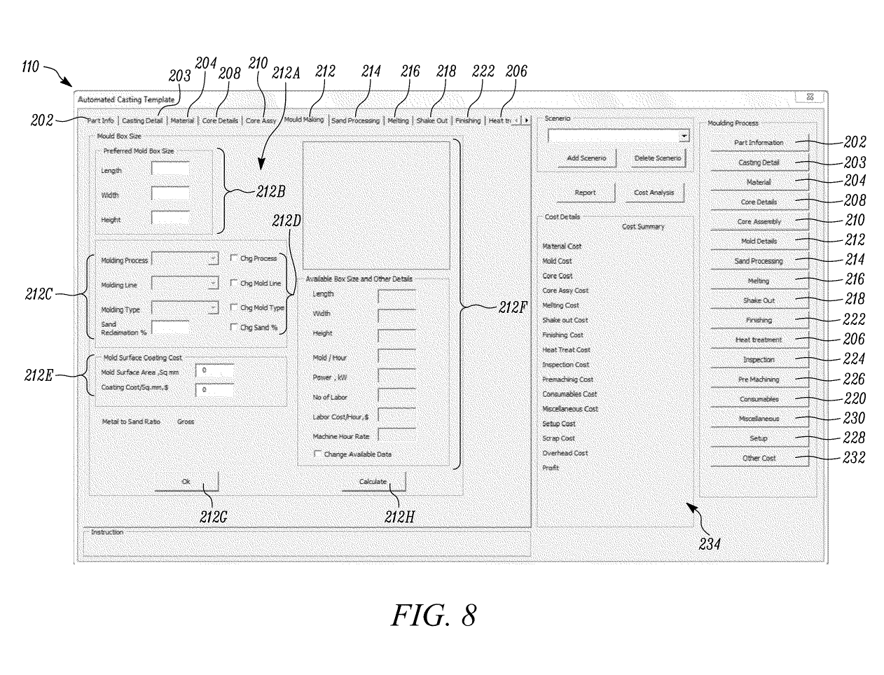

The mold making parameter may be selected via the navigation button 212. Referring to FIG. 8, the processing device 120 may display a process tab 212A on the GUI 110 as the user clicks on the navigation button 212. The process tab 212A may allow the user to provide input that is indicative of variables associated with the mold making parameter. The variables may be for example, mould box size, molding process, a molding line, a molding type, a percentage of sand reclamation etc. The process tab 212A may include one or more control elements that may allow the user to provide input indicative of the variables associated with the mold making parameter.

The process tab 212A may include a control element 212B that may allow the user to input preferred mold box size. Moreover, a length, a width and a height of the mold box may be input via one or more input boxes of the control element 212B. The process tab 212A may include control elements 212C that may allow the user to provide input corresponding to selection of the variables such as, a molding process, a molding line, a molding type and a percentage of sand reclamation. The control elements 212C may be drop-down menus, input boxes or other known graphic control elements. Further, each control elements 212C may be associated with control elements 212D. The control elements 212D may be radio buttons or check boxes. The inputs provided via the control elements 212C may be changed by selecting the corresponding control elements 212D.

The processing device 120 may be configured to lookup the database 130 and retrieve cost information associated with the mold making parameter such as, a mold surface area and associated coating cost from the database 130. The processing device 120 may also be configured to auto-fill the retrieved cost information via the control elements 212E of the process tab 212A for display to the user on the GUI 110. Alternatively, the control elements 212E may also allow the user to input the mold surface area and the coating cost.

The process tab 212A may include control elements 212F that may allow the user to input details of available box size, and other cost details. For example, the control elements 212F may include multiple input boxes that may allow the user to input data such as, a length, a height and, a width of the box, mold per hour, power, number of labor, labor cost per hour, machine hour rate etc. Further, the processing device may allow the user to change the data input via the control elements 212F upon receiving an instruction via a radio button or a check box.

The process tab 212A may also include an acceptance button 212G. Upon clicking on the acceptance button 212G, the processing device 120 may be configured to store the data received via the control elements 212B to 212F for further processing. Moreover, the process tab 212 may also include a control element 212H that may allow the user to provide an instruction to the processing device 120 to calculate the cost of mold making. The control element 212H may be a select button. Upon clicking the control element 212H, the processing device 120 may calculate the cost of mold making based on the data provided via various control elements of the GUI 110.

In the illustrated embodiment, the GUI 110 may include navigation buttons 214, 216, 218, 220 that may allow the user to provide input corresponding to selection of the foundry process parameters. The foundry process parameters may include parameters such as, sand processing, melting, shake-out and consumable parameter. Specifically, the navigation buttons 214, 216, 218, 220 may allow the user to provide input corresponding to selection of a sand processing parameter, melting parameter, shake-out parameter and consumable parameter respectively.

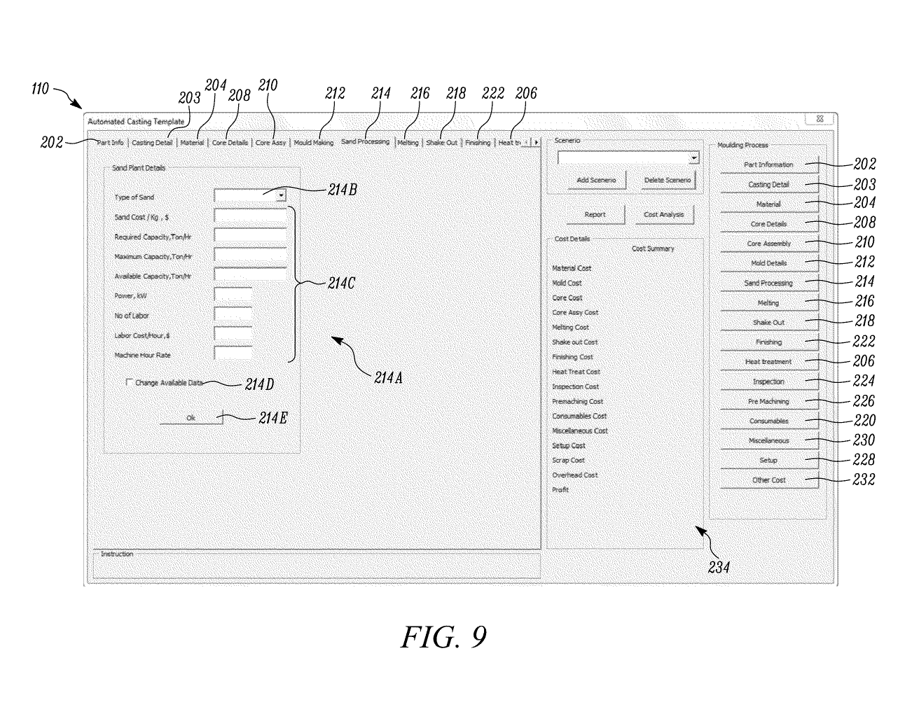

The sand processing parameter may be selected via the navigation button 214. Referring to FIG. 9, the processing device 120 may display a process tab 214A on the GUI 110 as the user clicks on the navigation button 214. The process tab 214A may allow the user to provide input that is indicative of variables associated with the sand processing parameter. The variables may be for example, a type of sand, cost of sand per unit, required capacity, maximum capacity, available capacity, power, number of labor, cost of labor, machine hour rate etc. The process tab 212A may include one or more control elements that may allow the user to provide input indicative of the variables associated with the sand processing parameter.

The process tab 214A may include control elements 214B that allow the user to provide input corresponding to selection of a type of sand. The process tab 214A may include control elements 214C that allow the user to provide input indicative of the cost information and the variables such as, cost of sand, required capacity, maximum capacity, available capacity, power, number of labor, cost of labor, machine hour rate etc. Alternatively, the processing device 120 may be configured to lookup the database 130 and retrieve cost information and one or more variables associated with the sand processing parameter from the database 130. The processing device 120 may be configured to auto-fill the retrieved data via the control elements 214C for display to the user on the GUI 110. The processing device 120 may allow the user to change the data input via the control elements 214C, upon selecting a control element 214D. The control element 214D may be a radio button or a check box

Further, the process tab 214A may also include a control element 214E that may allow the user to give an instruction to calculate a sand processing cost associated with the sand processing parameter. The processing device 120 may receive the instruction via the control element 214E and determines the sand processing cost. The processing device 120 may determine the sand processing cost based on the cost information and the variables associated with the sand processing parameter received via the control elements 214B to 214D and other relevant data retrieved from the database 130.

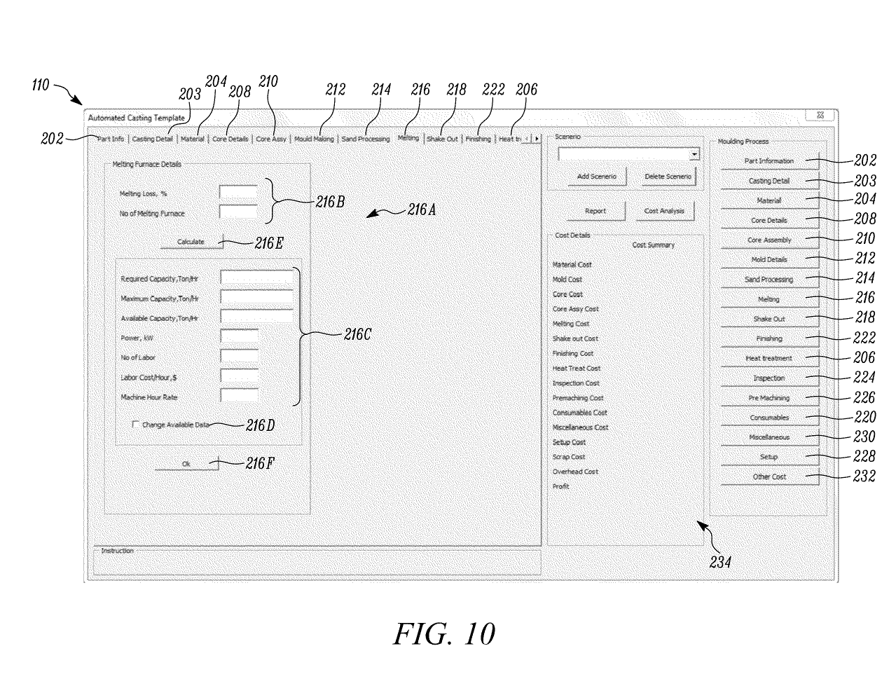

The melting parameter may be selected via the navigation button 216. Referring to FIG. 10, the processing device 120 may display a process tab 216A on the GUI 110 as the user clicks on the navigation button 216. The process tab 216A may allow the user to provide input that is indicative of variables associated with the melting parameter. The variables may be for example, melting furnace details such as, percentage of melting loss, number of melting furnace etc. The process tab 216A may include one or more control elements that may allow the user to provide input indicative of the variables associated with the melting parameter.

The process tab 216A may include control elements 216B that allow the user to input data indicative of the variables such as, percentage of melting loss, number of melting furnace. Moreover, upon clicking a control element 216E of the process tab 216A, the processing device 120 may receive the data input via the control element 216B and store the data for further processing

The processing device 120 may be configured to lookup the database 130 and retrieve cost information and one or more variables associated with the melting parameter such as, required capacity, maximum capacity, available capacity, power, number of labor, cost of labor, machine hour rate etc. from the database 130. The processing device 120 may also be configured to auto-fill the retrieved cost information via control elements 216C of the process tab 216A for display to the user on the GUI 110. Alternatively, the control elements 216C may also allow the user to input the cost information. Upon selecting a control element 216D, the processing device 120 may allow the user to change the input provided via the control elements 216C. The control element 216D may be a radio button or a check box.

The process tab 216A may also include a control element 216F that allows the user to give an instruction corresponding to calculation of melting cost. The processing module may receive the instruction via the control element 216F and determines the melting cost based on the cost information and the variables associated with the melting parameter received via the control elements 216B to 216E of the process tab 216A.

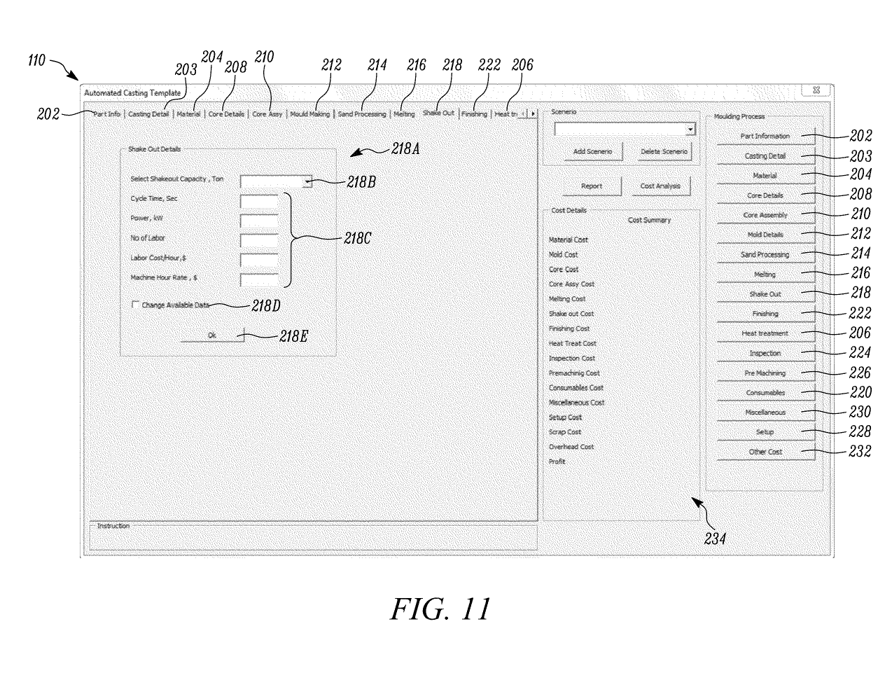

The shake out parameter may be selected via the navigation button 218. Referring to FIG. 11, the processing device 120 may display a process tab 218A on the GUI 110 as the user clicks on the navigation button 218. The process tab 218A may allow the user to provide input that is indicative of variables associated with the shake out parameter. The variables may be for example, a capacity of shake-out. The process tab 218A may include one or more control elements that may allow the user to provide input indicative of the variables associated with the shake-out parameter.

The process tab 218A may include control element 218B that allows the user to provide input corresponding to selection of the shake-out capacity. The processing device 120 may be configured to lookup the database 130 and retrieve cost information and one or more variables associated with the shake-out parameter such as, cycle time, power, number of labor, cost of labor, machine hour rate etc. from the database 130. The processing device 120 may also be configured to auto-fill the retrieved information via control elements 218C of the process tab 218A to be visible to the user on the GUI 110. Alternatively, the control elements 218C may also allow the user to input one or more details. Upon selecting a control element 218D, the processing device 120 may allow the user to change the input provided via the control elements 218C. The control element 218D may be a radio button or a check box.

Further, the process tab 218A may also include a control element 218E that may allow the user to give an instruction to calculate a shake-out cost. The processing device 120 may receive the instruction via the control element 210E and determines the shake-out cost associated with the shake-out parameter. The processing device 120 may determine the cost based on the cost information and the variables associated with the shake-out parameter received via the control elements 210B to 210D and other relevant data retrieved from the database 130.

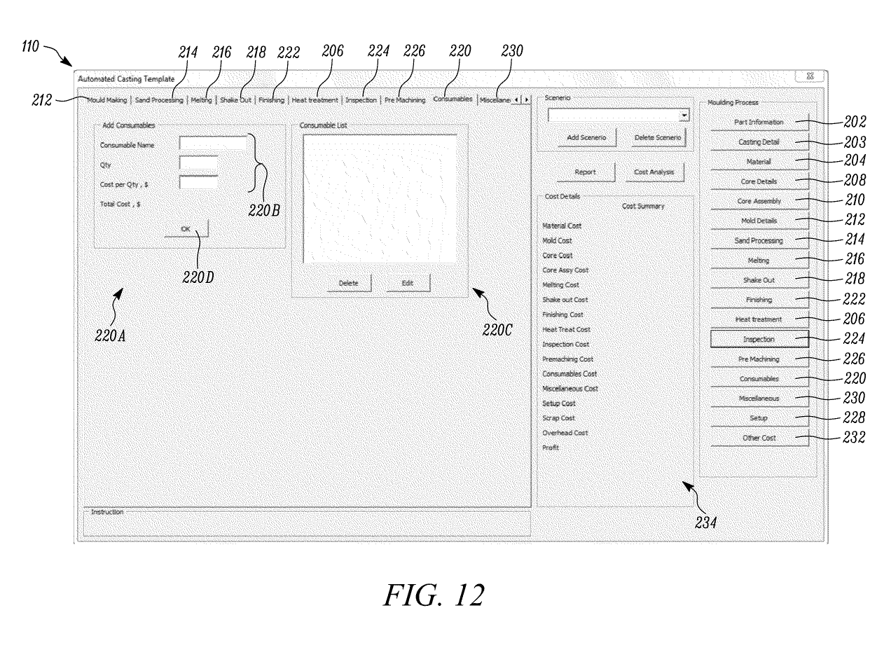

The consumables parameter may be selected via the navigation button 220. Referring to FIG. 12, the processing device 120 may display a process tab 220A on the GUI 110 as the user clicks on the navigation button 220. The process tab 220A may allow the user to provide input that is indicative of variables associated with the consumables parameter. The variables may be for example, name of consumable, quantity of the consumable, cost per quantity etc. The process tab 220A may include one or more control elements that may allow the user to provide input indicative of the variables associated with the consumables parameter.

The process tab 220A may include control elements 220B that allow the user to input data indicative of the variables such as, name of consumable, quantity of the consumable, cost per quantity. The processing device 120 may allow the user to add multiple consumables for subsequent cost calculation. The process tab 220A may include a control element 220C that allow deleting or editing of one or more added consumables.

Further, the process tab 220A may also include a control element 220D that may allow the user to give an instruction to calculate a consumable cost associated with the consumable parameter. The processing device 120 may receive the instruction via the control element 220D and determines the consumable cost. The processing device 120 may determine the cost based on the cost information and the variables associated with the consumable parameter received via the control elements 220B and 220C.

In the illustrated embodiment, the GUI 110 may include navigation buttons 222, 224, 226, 228 that may allow the user to provide input corresponding to selection of the machining and setup parameters. The machining and setup parameters may include parameters such as, pre-machining, finishing, inspection and setup parameter. Specifically, the navigation buttons 222, 224, 226, 228 may allow the user to provide input corresponding to selection of the finishing parameter, the inspection parameter the pre-machining parameter and the setup parameter respectively.

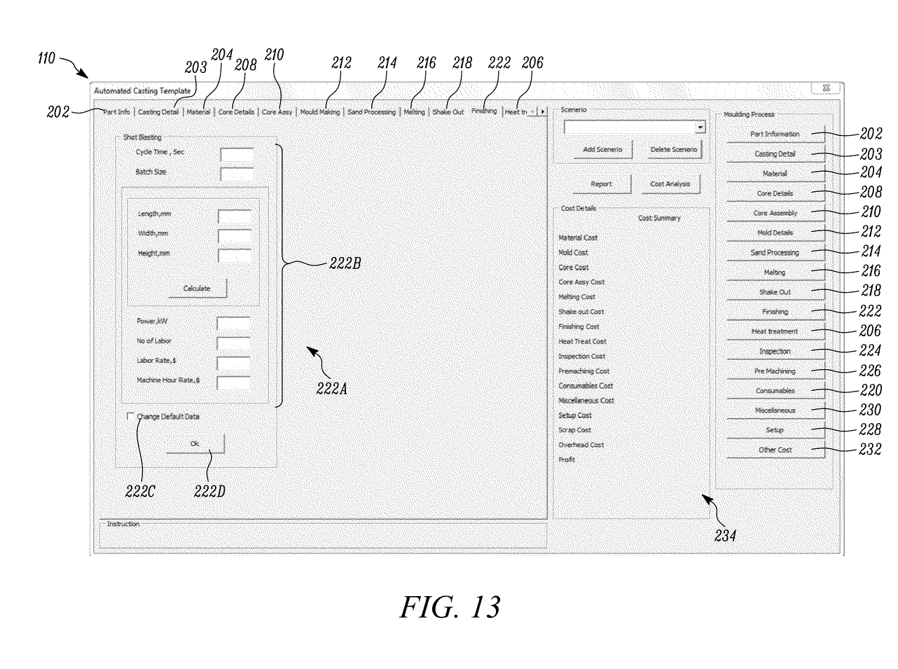

The finishing parameter may be selected via the navigation button 222. Referring to FIG. 13, the processing device 120 may display a process tab 222A on the GUI 110 as the user clicks on the navigation button 222. The process tab 222A may allow the user to provide input that is indicative of variables associated with the finishing parameter. The variables may be for example, cycle time, batch size, size of shot blast, power, number of labor, cost of labor, machine hour rate etc. The process tab 222A may include one or more control elements that may allow the user to provide input indicative of the variables associated with the finishing parameter.

The process tab 222A may include control elements 222B that may allow the user to provide input indicative of one or more variables associated with the finishing parameter. Alternatively, processing device 120 may lookup the database 130 and retrieve cost information and one or more variables associated with the finishing parameter from the database 130. The processing device 120 may also be configured to auto-fill the retrieved information via the control elements 222B to be visible to the user on the GUI 110. Upon selecting a control element 222C, the processing device 120 may allow the user to change the input provided via the control elements 222B. The control element 222C may be a radio button or a check box.

The process tab 222A may also include a control element 222D that may allow the user to give instruction corresponding to calculation of a finishing cost associated with the finishing parameter. The processing module may receive the instruction via the control element 222D and may calculate the finishing cost.

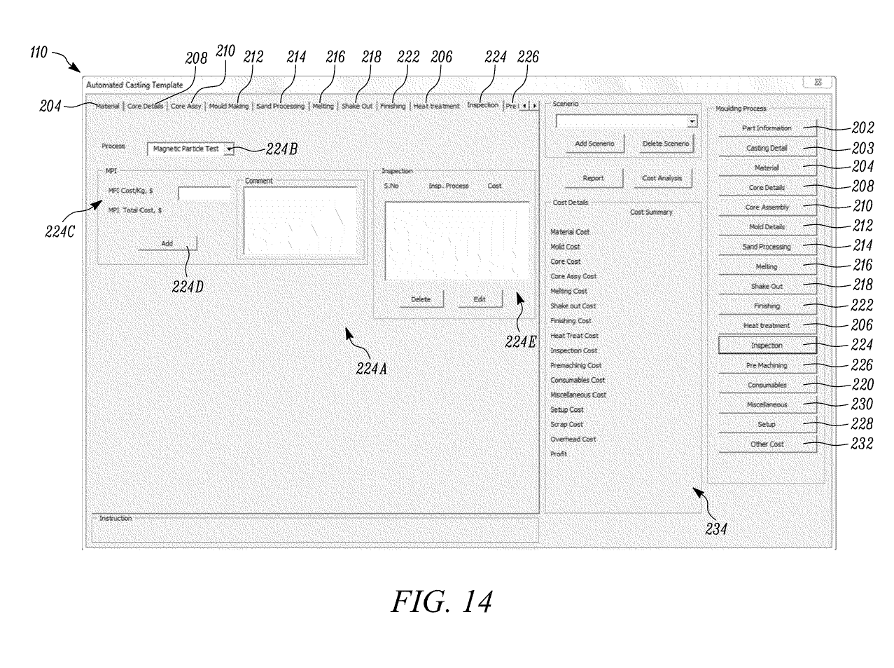

The inspection parameter may be selected via the navigation button 224. Referring to FIG. 14, the processing device 120 may display a process tab 224A on the GUI 110 as the user clicks on the navigation button 224. The process tab 224A may allow the user to provide input that is indicative of variables associated with the inspection parameter. The variables may be for example, process of inspection. The process tab 224A may include one or more control elements that may allow the user to provide input indicative of the variables associated with the inspection parameter.

The process tab 224A may include a control element 224B that may allow the user to provide input corresponding to selection of the process of inspection. The processing device 120 may be configured to lookup the database 130 and retrieve cost information associated with the selected process of inspection from the database 130. The processing device 120 may also be configured to auto-fill the retrieved cost information via control element 224C of the process tab 224A for display to the user on the GUI 110. Alternatively, the control elements 224C may allow the user to input the cost information.

Upon clicking a control element 224D, the processing device 120 may allow the user to add a process of inspection and associated cost for subsequent cost calculation. The processing device 120 may also allow the user to add multiple process of inspection. The process tab 224A may include control elements 224E that may allow the user to provide input corresponding to deletion or editing of one or more process added.

Further, the processing device 120 may be configured to calculate a inspection cost associated with the inspection parameter based on the cost information and the variables via the control elements 224B to 224E of the GUI 110.

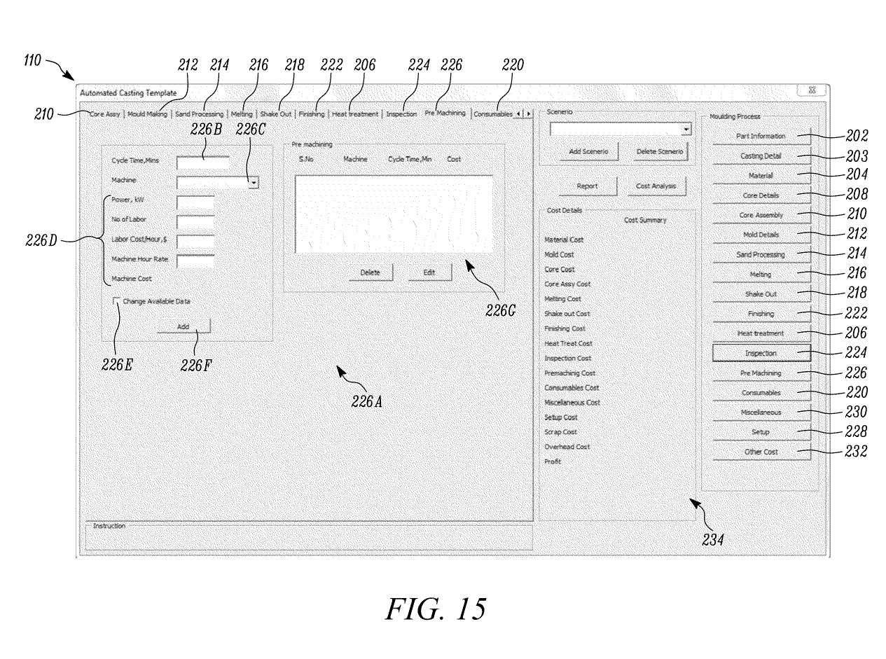

The pre-machining parameter may be selected via the navigation button 226. Referring to FIG. 15, the processing device 120 may display a process tab 226A on the GUI 110 as the user clicks on the navigation button 226. The process tab 226A may allow the user to provide input that is indicative of variables associated with the pre-machining parameter. The variables may be, for example, machine, cycle time etc. The process tab 226A may include one or more control elements that may allow the user to provide input indicative of the variables associated with the pre-machining parameter.

The process tab 226A may include control elements 226B, 226C that may allow the user to provide input that is indicative the cycle time and the machine respectively. The processing device 120 may be configured to lookup the database 130 and retrieve cost information associated with the pre-machining parameter from the database 130. The cost information may include power, number of labor, labor cost, machine hour rate, machine cost etc. The processing device 120 may also be configured to auto-fill the retrieved cost information via control element 226D of the process tab 226A for display to the user on the GUI 110. Alternatively, the control elements 226C may allow the user to input the cost information. The processing device 120 may also allow the user to change the cost information upon receiving an instruction via a control element 226E of the process tab 226A.

Upon clicking a control element 226F, the processing device 120 may allow may allow the user to add a machine used and associated cost for subsequent cost calculation. The processing device 120 may also allow the user to add multiple machines. The process tab 226A may include control elements 226G that may allow the user to provide input corresponding to deletion or editing of one or more machines added.

Further, the processing device 120 may be configured to calculate a pre-machining cost associated with the pre-machining parameter based on the cost information and the variables via the control elements 226B to 226G of the GUI 110.

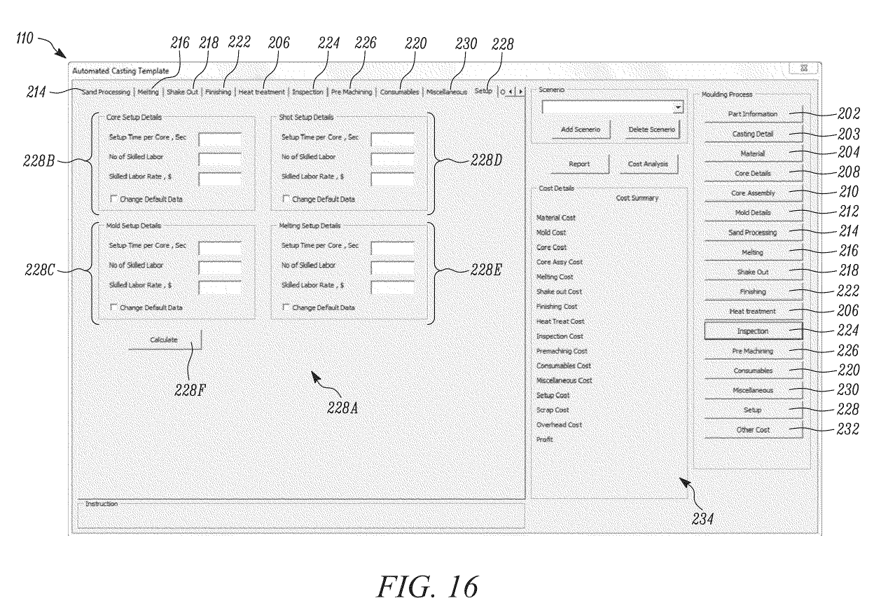

The setup parameter may be selected via the navigation button 228. Referring to FIG. 16, the processing device 120 may display a process tab 228A on the GUI 110 as the user clicks on the navigation button 228. The process tab 228A may allow the user to provide input that is indicative of variables associated with the setup parameter. The variables may be, for core setup, shot setup, mold setup, melting setup details etc. The process tab 228A may include one or more control elements that may allow the user to provide input indicative of the variables associated with the setup parameter.

The process tab 228A may include control elements 228B, 228C, 228D, 228E that may allow the user to provide input that is indicative of the core setup, shot setup, mold setup, melting setup details respectively. Moreover, the processing device 120 may be configured to lookup the database 130 and retrieve cost information associated with the pre-machining parameter from the database 130. The cost information may include skilled labor rate. The processing device 120 may also be configured to auto-fill the retrieved cost information via the control elements 228B, 228C, 228D and 228E for display to the user on the GUI 110. The processing device 120 may also the user to change the data input via the control elements 228B, 228C, 228D.

Further, the process tab 228A may also include a control element 228F that may allow the user to give an instruction to calculate a setup cost associated with the setup parameter. The processing device 120 may receive the instruction via the control element 228F and determines the setup cost. The processing device 120 may determine the cost based on the cost information and the variables associated with the setup parameter received via the control elements 228B to 228E.

Further, the GUI 110 may also include control element 230 that may allow the user to provide inputs corresponding to selection of miscellaneous parameters. The miscellaneous parameters may be for example, type of process such as, painting, cycle time etc. Additionally, the GUI 110 may include a control element 232 that may allow the user to provide inputs corresponding to selection of parameters related to scrap cost, overhead cost, profit cost etc. The processing device 120 may be configured to calculate the miscellaneous cost and other cost based on inputs received via the control elements 230, 232 respectively.

The GUI 110 may also include a process tab 234 that displays parameter costs associated with various casting parameters. Moreover, the processing device 120 may be configured to determine the parameter cost and auto-fill the determined parameter costs via the process tab 234 for display to the user. The parameter costs as described earlier in the disclosure may be material cost, mold making cost, core making cost, core assembly cost, melting cost, shake-out cost, finishing cost, heat treatment cost, inspection cost, pre-machining cost, consumables cost, setup cost and other costs. Further, the processing device 120 may also be configured to add parameter costs associated with corresponding casting parameters of the casting process to obtain a total cost. The total cost may be displayed on the process tab 234.

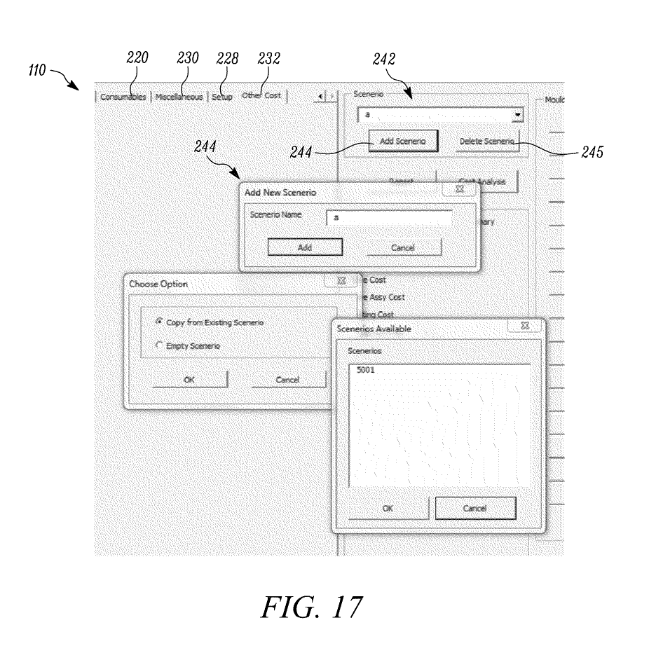

Moreover, the processing device 120 may also be configured to generate an output indicative of a cost of the casting process in different scenarios. Referring to FIG. 17, the GUI 110 may include a control element 242 that may allow the user to provide input corresponding to selection of a scenario. The control element 242 that may allow the user to select the scenario from multiple scenarios in the database 130. The processing device 120 may be configured to receive the input to select the scenario via the control elements 242. The GUI 110 may also include a control element 244 and a control element 245. The processing device 120 may allow adding one or more scenarios to the database 130 upon receiving an instruction via the control element 244. The processing device 120 may allow deleting one or more scenarios from the database 130 upon receiving an instruction via the control element 245.

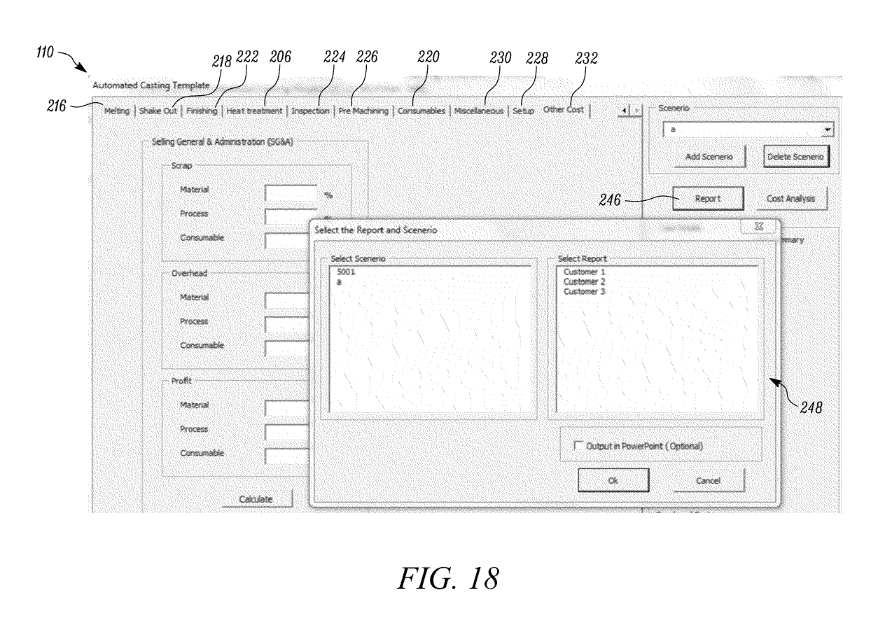

Referring to FIG. 18, the GUI 110 may include a control element 246 that may allow the user to provide input that is indicative of an output parameter. The output parameter may be associated with a type of customer. For example, the output parameter may vary for a United States customer and a Brazil customer. Moreover, each scenario may be associated with different output parameters. As such, an output parameter for a particular scenario may be selected or input via the control element 246. The processing device 120 may display a dialogue box 248 that includes a list of report formats corresponding to each of the output parameters. The dialogue box 248 may allow the user to provide input corresponding to selection of the report formats.

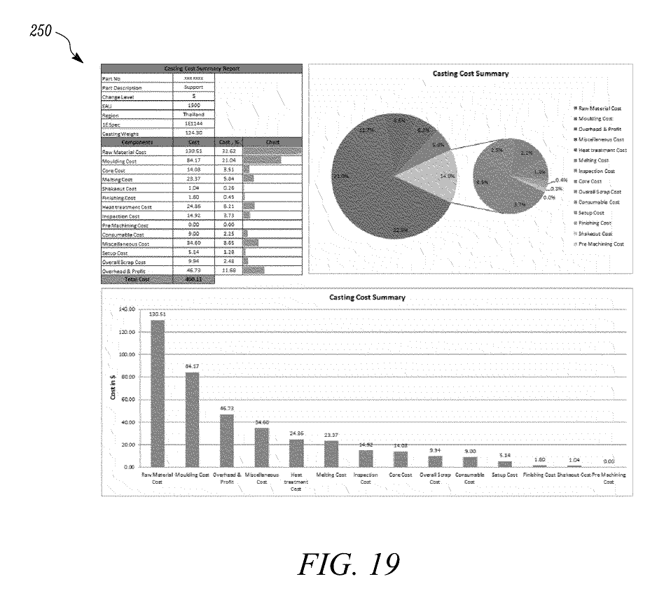

Referring to FIG. 19, the processing device 120 may be configured to receive input via the dialogue box 248 and generate an output 250 based on the selected report format and the selected scenario. For example, the processing device 120 may generate the output 250 that includes casting cost summary in a table, a graphical and a pie-chart representation. Further, the processing device 120 may save the output 250 in a file in the database 130 based on a user input received via one or more control elements of the GUI 110. Moreover, the processing device 120 may also be configured to lookup the database 130 and retrieve one or more files. Further, the processing device 120 may be configured to compare the costing details associated with the retrieved files. The processing device 120 may be further configured to generate an output based on the comparison.

A person of ordinary skill in the art will acknowledge that the GUI 110 and the corresponding graphical control elements explained above are merely exemplary in nature and hence non-limiting of this disclosure. Moreover, necessary design and/or functional modifications may be possible for the GUI 110 without deviating from the scope of the present disclosure.

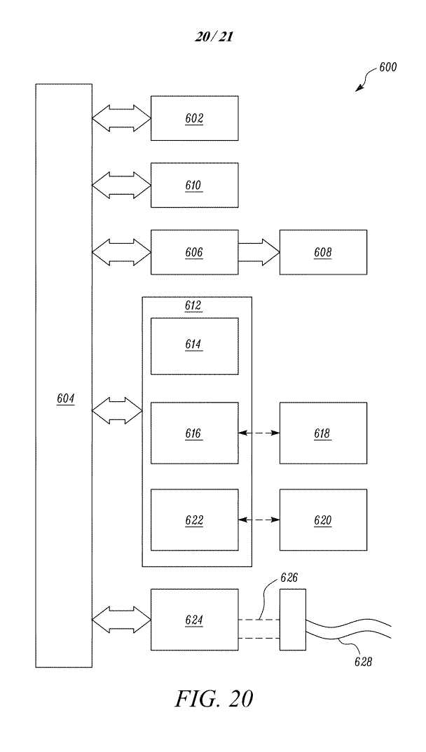

In fact, in accordance with an embodiment of the present disclosure, the present disclosure is directed towards one or more computer systems capable of carrying out the functionality described herein. An example of the computer based system includes a computer based system 600, which is shown by way of a block diagram in FIG. 20.

The computer based system 600 includes at least one processor, such as a processor 602. The processor 602 may be connected to a communication infrastructure 604, for example, a communications bus, a cross-over bar, a network, and the like. Various software embodiments are described in terms of this exemplary computer based system 600. Upon perusal of the present description, it will become apparent to a person skilled in the relevant art(s) how to implement the present disclosure using other computer systems and/or architectures.

The computer based system 600 includes a display interface 606 that forwards graphics, text, and other data from the communication infrastructure 604, or from a frame buffer (not shown) for display on a display unit 608.

The computer based system 600 further includes a main memory 610, such as random access memory (RAM), and may also include a secondary memory 612. The secondary memory 412 may further include, for example, a hard disk drive 614 or a removable storage drive 616, representing a floppy disk drive, a magnetic tape drive, an optical disk drive, etc. The removable storage drive 616 reads from and/or writes to a removable storage unit 618 in a well known manner. The removable storage unit 618 may represent a floppy disk, magnetic tape or an optical disk, and may be read by and written to by the removable storage drive 616. As will be appreciated, the removable storage unit 618 includes a computer usable storage medium having stored therein, computer software and/or data.

In accordance with various embodiments of the present disclosure, the secondary memory 612 may include other similar devices for allowing computer programs or other instructions to be loaded into the computer based system 600. Such devices may include, for example, a removable storage unit 620, and an interface 622. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit 620 to the computer based system 600.

The computer based system 600 may further include a communication interface 624. The communication interface 624 allows software and data to be transferred between the computer based system 600 and external devices. Examples of the communication interface 624 include, but may not be limited to a modem, a network interface (such as an Ethernet card), a communications port, a Personal Computer Memory Card International Association (PCMCIA) slot and card, and the like. Software and data transferred via the communication interface 624 may be in the form of a plurality of signals, hereinafter referred to as signals 626, which may be electronic, electromagnetic, optical or other signals capable of being received by the communication interface 624. The signals 626 may be provided to the communication interface 624 via a communication path (e.g., channel) 628. The communication path 628 carries the signals 626 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 616, a hard disk installed in the hard disk drive 614, the signals 626, and the like. These computer program products provide software to the computer based system 600. The present disclosure is directed to such computer program products.

Computer programs (also referred to as computer control logic) may be stored in the main memory 610 and/or the secondary memory 612. The computer programs may also be received via the communication interface 604. Such computer programs, when executed, enable the computer based system 600 to perform the functions consistent with the present disclosure, as discussed herein. In particular, the computer programs, when executed, enable the processor 602 to perform the features of the present disclosure. Accordingly, such computer programs represent controllers of the computer based system 600.

In accordance with an embodiment of the present disclosure, where the disclosure is implemented using a software, the software may be stored in a computer program product and loaded into the computer based system 600 using the removable storage drive 616, the hard disk drive 614 or the communication interface 624. The control logic (software), when executed by the processor 602, causes the processor 602 to perform the functions of the present disclosure as described herein.

In another embodiment, the present disclosure is implemented primarily in hardware using, for example, hardware components, such as, application specific integrated circuits (ASIC) Implementation of the hardware state machine so as to perform the functions described herein will be apparent to persons skilled in the relevant art(s). In yet another embodiment, the present disclosure is implemented using a combination of both the hardware and the software.

Various embodiments disclosed herein are to be taken in the illustrative and explanatory sense, and should in no way be construed as limiting of the present disclosure. All numerical terms, such as, but not limited to, “first” and “second” or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

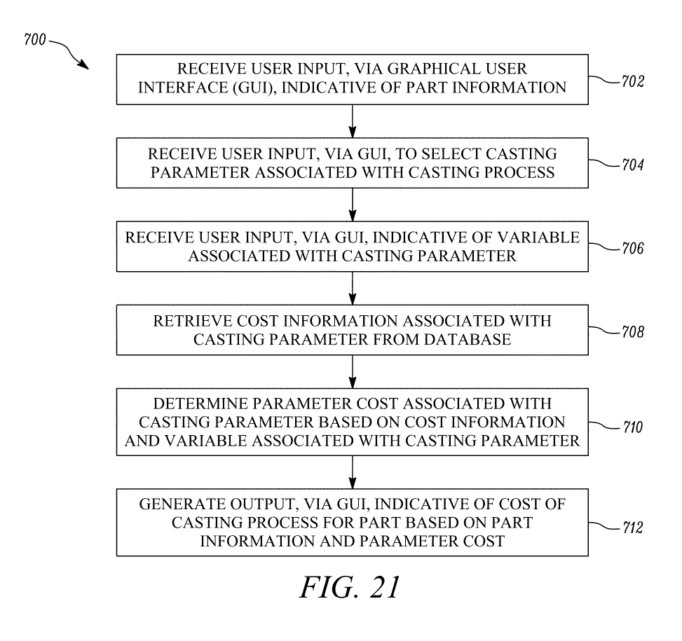

FIG. 21 illustrates a flowchart of a computer-implemented method 700 for determining a cost of a casting process, according to an embodiment of the preset disclosure. In an embodiment, the method 700 may be implemented via the system 100 described above.

At step 702, the method 700 includes receiving a user input via the GUI 110 that is indicative of part information. The part information may be associated with a part manufactured by the casting process. In the illustrated embodiment, the control element 202 may allow the user to provide input corresponding to selection of the part information parameter. Further, the process tab 202A of the GUI 110 may allow the user to provide an input indicative of the part information. Further, the processing device 120 may be configured to receive the part information via the control elements 202B to 202G of the process tab 202A.

At step 704, the method 700 includes receiving a user input, via the GUI 110, to select a casting parameter associated with the casting process. The casting parameter may include the material and post-treatment parameter, the mold and core parameter, the foundry process parameter and the machining and setup parameter. In the illustrated embodiment, various navigation buttons of the GUI 110 may allow the user to provide an input corresponding to selection of the casting parameters. For example, the navigation button 204 of the GUI 110 may allow the user to provide an input corresponding to selection of the material data parameter. Further, the processing device 120 may be configured to select the material data parameter upon receiving the user input via the navigation button 204.

At step 706, the method 700 includes receiving via, the GUI 110, a user input that is indicative of a variable associated with the casting parameter. In the illustrated embodiment, the processing device 120 may display or navigate to a process tab associated with the casting parameter upon receiving instruction via the navigation buttons. The control elements of the process tab may allow the user to provide an input that is indicative of the variables associated with the selected casting parameter. For example, upon selecting the material data parameter via the navigation button 204, the processing device 120 may display or navigate to the process tab 204A (See FIG. 4) of the GUI 110. The control elements 204B to 204K of the process tab 204A may allow the user to provide an input that is indicative of the variables associated with the material data parameter such as, type of material, type of scrap etc. Further, the processing device 120 may be configured to receive the user input via at least one of the control elements 204B to 204I.

At step 708, the method 700 may include retrieving a cost information, via the GUI 110, that is associated with the casting parameter from the database 130. The cost information may include at least one of a material cost, machine cost, a regional cost and the like. For example, the processing device 120 may lookup the database and retrieve cost information associated with the material data parameter such as, alloy cost, foundry returns cost and the like from the database 130. The processing device 120 may also be configured to auto-fill the cost information via the control elements 204J for display to the user on the GUI 110.

At step 710, the method 700 includes determining a parameter cost associated with the casting parameter based on the cost information and the variable associated with the costing parameter. In the illustrated embodiment, the processing device 120 may determine parameter costs associated with various casting parameters based on the user input provided via the GUI 110 and data retrieved from the database 130. For example, the processing device 120 may determine the material cost associated with the material data parameter based on the input indicative of the variables received via the control elements 204B to 204I and the cost information retrieved from the database 130. The processing device 120 may determine costs associated with various other casting parameters such as, the mold cost, core cost, core assembly cost, melting cost, shake-out cost, finishing cost, heat treat cost, inspection cost, pre-machining cost, consumables cost, setup cost etc. Further, the processing device may display the parameter costs via the process tab 234 of the GUI 110.

At step 710, the method 700 further includes adding parameter costs associated with the casting parameters of the casting process to obtain the total cost of the casting process.

At step 712, the method 700 includes generating an output via the GUI 110, indicative of the cost of the casting process for the part based on the part information and the parameter cost. The processing device 120 may generate the output 250 (shown in FIG. 19) via the GUI 110, indicative of the cost of the casting process for the part based on the part information and the parameter cost.

At step 712, the method 700 may further include receiving a user input, via the GUI 110, indicative of an output parameter and generating the output based on the output parameter. In the illustrated embodiment, the control element 246 may allow the user to provide an input indicative of the output parameter. The processing device 120 may receive the input via the control element 246 and generate the output based on the received input.

At step 712, the method 700 may include saving a file indicative of the cost associated with the casting process in the database based on a user input. The processing device 120 may generate the output indicative of the cost of the casting process and save a file indicating the output in the database. The GUI 110 may include one or more control elements that allow the user to give an instruction to the processing device 120 corresponding to saving of the file in the memory. Moreover, the method 700 may also include retrieving a plurality of files indicative of the costs associated with corresponding casting processes based on a user input. The method may also include comparing costs with each other and generating the output based on the comparison.

The system 100 and the method 700 of the present disclosure have applicability for use and implementation in determining a cost of a casting process. With such implementation, a cost of a casting process may be determined by taking into account various parameters, thereby accurately determining the total cost of the casting process. Additionally, with use of the system 100 and the method 700, output may be generated according to various scenarios and types of customers. The system 100 and the method 700 may also allow saving a file including the various parameter costs within the database 130 such that the file may be retrieved and modified later. Two or more such files may also be retrieved to obtain a comparison of the various parameter costs associated with each of the files. Hence, an optimum casting process may be determined based on the comparison.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A computer implemented method for determining a cost of a casting process, the method comprising:
receiving a user input, via a Graphical User Interface (GUI), indicative of a part information, wherein the part information is associated with a part manufactured by the casting process;
receiving a user input, via the GUI, to select a casting parameter associated with the casting process, wherein the casting parameter comprises a material and post-treatment parameter, a mold and core parameter, a foundry process parameter, and a machining and setup parameter;
receiving a user input, via the GUI, indicative of a variable associated with the casting parameter;
retrieving a cost information associated with the casting parameter from a database;
determining a parameter cost associated with the casting parameter based on the cost information and the variable associated with the casting parameter; and
generating an output, via the GUI, indicative of the cost of the casting process for the part based on the part information and the parameter cost.

2. The method of claim 1, further comprising:
receiving a user input, via the GUI, indicative of an output parameter; and
generating the output based on the output parameter.

3. The method of claim 2, wherein the output parameter is associated with a customer type.

4. The method of claim 1, wherein the part information includes a part number associated with a part file.

5. The method of claim 1, wherein the material and post-treatment parameter includes material type, scrap type and heat treatment.

6. The method of claim 1, wherein the mold and core parameter includes core making, core assembly and mold making.

7. The method of claim 1, wherein the foundry process parameter includes sand processing, melting, shake-out and consumables.

8. The method of claim 1, wherein the machining and setup parameter includes pre-machining, finishing, inspection and setup.

9. The method of claim 1, wherein the cost information includes at least one of a material cost, a machine cost, and a regional cost.

10. The method of claim 1, further comprising adding parameter costs associated with corresponding casting parameters of the casting process to obtain a total cost.

11. The method of claim 1, further comprising saving a file, based on a user input, indicative of the cost associated with the casting process in the database.

12. The method of claim 11, further comprising:
retrieving, from the database, a plurality of files indicative of the costs associated with corresponding casting processes;
comparing the costs with each other; and
generating the output based on the comparison.

13. A system for determining a cost of a casting process, the system comprising:
a Graphical User Interface (GUI) configured to receive a user input;
a database configured to store information associated with the casting process;
a processing device in communication with the GUI and the database, the processing device configured to:
receive a part information associated with a part manufactured by the casting process;
select a casting parameter associated with the casting process based on a user input, wherein the casting parameter comprises a material and post-treatment parameter, a mold and core parameter, a foundry process parameter, and a machining and setup parameter
receive a variable associated with the casting parameter;
retrieve a cost information associated with the casting parameter from the database;
determine a parameter cost associated with the casting parameter based on the cost information and the variable associated with the casting parameter; and
generate an output indicative of the cost of the casting process for the part based on the part information and the parameter cost.

14. The system of claim 13, wherein the processing device is further configured to:
receive a user input, via the GUI, indicative of an output parameter; and
generate the output based on the output parameter.

15. The system of claim 14, wherein the output parameter is associated with a customer type.

16. The system of claim 13, wherein the cost information includes at least one of a material cost, a machine cost and, a regional cost.

17. The system of claim 13, wherein the processing device is further configured to add parameter costs associated with corresponding casting parameters of the casting process to obtain a total cost.

18. The system of claim 13, wherein the processing device is further configured to save a file, based on a user input, indicative of the cost associated with the casting process in the database.

19. The system of claim 18, wherein the processing device is further configured to:
retrieve a plurality of files, from the database, indicative of the costs associated with corresponding casting processes;
compare the costs with each other; and
generate the output based on the comparison.

20. A computer program product embodied on a non-transitory computer readable medium for determining a cost of a casting process, the computer program product causing a computer to perform operations comprising:
receiving a user input, via a Graphical User Interface (GUI), indicative of a part information, wherein the part information is associated with a part manufactured by the casting process;
receiving a user input, via the GUI, to select a casting parameter associated with the casting process, wherein the casting parameter comprises a material and post-treatment parameter, a mold and core parameter, a foundry process parameter, and a machining and setup parameter;
receiving a user input, via the GUI, indicative of a variable associated with the casting parameter;
retrieving a cost information associated with the casting parameter from a database;
determining a parameter cost associated with the casting parameter based on the cost information and the variable associated with the casting parameter; and
generating an output, via the GUI, indicative of the cost of the casting process for the part based on the part information and the parameter cost.
